(19) United States
(12) Patent Application Publication
(10) Pub. No.: US 2013/0311409 A1
(43) Pub. Date: Nov. 21, 2013

(54) Web-Based Education System

(71) Applicant: Veetle, Inc., Palo Alto, CA (US)

(72) Inventors: Jun Ye, Palo Alto, CA (US); Roger Fabian Wedgwood Pease, Palo Alto, CA (US)

(73) Assignee: Veetle, Inc., Palo Alto, CA (US)

(21) Appl. No.: 13/895,265

(22) Filed: May 15, 2013

Related U.S. Application Data
(60) Provisional application No. 61/648,621, filed on May 18, 2012.

(51) Int. Cl. G06N 99/00

(52) U.S. Cl. CPC G06N 99/005
USPC 706/12

(57) ABSTRACT

A web-based education system enables instructors to prepare and present online education courses and enables students to locate and participate in available courses. A machine learning algorithm generates a topic-based representation of courses and generates a topic-based representation of user interests. The web-education system then enables users to find relevant courses using the topic-based representations. Recommended courses are ranked according to factors such as relevance to the user, popularity, and course rating.

### RELATED APPLICATIONS

This application claims priority from U.S. provisional application No. 61/648,621 entitled “Education Cloud” to Jun Ye, et al. filed on May 18, 2012, the content of which is incorporated by reference herein in this entirety.

### BACKGROUND

1. Field of the Invention

The disclosed embodiments generally relate to a web-based education platform.

2. Description of the Related Arts

Online education platforms are becoming an increasingly popular alternative to traditional classrooms. For example, many universities now offer online classes available around the world. Similarly, a number of companies, organizations, and individuals provide web-based learning programs covering a wide range of topics. As the number of online education opportunities grow, it is desirable for potential students to be able to easily locate online classes that best match their interests.

### SUMMARY

A method, system, and non-transitory computer-readable storage medium matches prospective students with courses in a web-based education system. A plurality of course vectors are received with each course vector associated with an online course, and each course vector representing the course as a weighted distribution of topics associated with the course derived from a machine learning algorithm. A total interest vector is furthermore received for a user. The total interest vector representing interests of the user as a weighted distribution of topics associated with the user derived from the machine learning algorithm. Matching scores are generated between the total interest vector and the plurality of course vectors. References to one or more courses are outputted based on the matching scores.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 is a block diagram illustrating an embodiment of a web-based education system.

FIG. 2 is a flowchart illustrating an embodiment of a process for learning topics associated with a plurality of online courses.

FIG. 3 is a flowchart illustrating an embodiment of a process for performing a topic-based course search in response to a search query.

FIG. 4 is a flowchart illustrating an embodiment of a process for generating course recommendations for a user based on a user profile according to a topic-based approach.

FIG. 5 is a flowchart illustrating an embodiment of process for determining relationships between topics using a machine learning algorithm.

FIG. 6 is a flowchart illustrating an embodiment of a process for ranking course recommendations.

FIG. 7 is a flowchart illustrating an embodiment of a process for determining a course rating for an online course.

FIG. 8 is a flowchart illustrating an embodiment of a process for determining a popularity score for an online course.

### DETAILED DESCRIPTION

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

### SYSTEM ARCHITECTURE

A web-based education system enables instructors to prepare and present online education courses and enables students to locate and participate in available courses. A machine learning algorithm generates a topic-based representation of courses and generates a topic-based representation of user interests. The web-education system then enables users to find relevant courses using the topic-based representations. Recommended courses are ranked according to factors such as relevance to the user, popularity, and course rating.

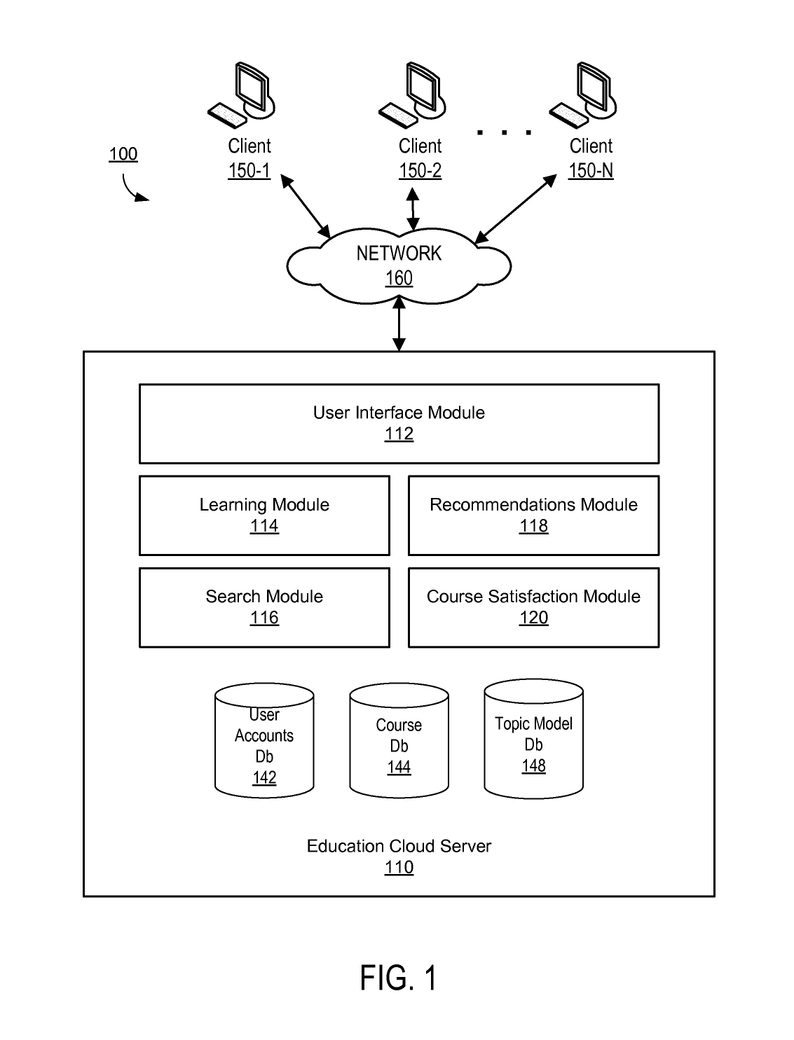

FIG. 1 illustrates one embodiment of a web-based education platform 100. The web-based education system 100 comprises an education cloud server 110 and a plurality of clients 150 (e.g., clients 150-1, 150-2, . . . , 150-N communicatively coupled via a network 160. Other embodiments can have different modules than the ones described here, and that the functionalities can be distributed among the modules in a different manner. In addition, the functions ascribed to the various modules can be performed by multiple engines.

A client 150 (e.g., clients 150-1, 150-2, . . . , 150-N) can be any type of computing device that is capable of supporting a communications interface to the education cloud server 110. Suitable devices may include, but are not limited to, personal computers, mobile computers (e.g., notebook computers), personal digital assistants (PDAs), smartphones, tablets, mobile phones, gaming consoles, and network-enabled viewing devices (e.g., set-top boxes, televisions, and receivers). The clients 150 each comprise one or more processors and one or more non-transitory computer-readable storage mediums (among other components) that enable the clients 150 to execute various applications as part of the web-based education system 100. For example, in one embodiment, a client 150 executes a web browser application that enables the client 150 to interact with the education cloud server via the network 160 and participate in online education courses via a web-based interface. In another embodiment, locally installed applications (or “apps”) may be designed specifically for use with the web-based education system 100 and provide customized interfaces for interacting with content from the education cloud server 110.

The network 160 may be a wired or wireless network. Examples of the network 160 include the Internet, an intranet, a WiFi network, a WiMAX network, a cellular network (e.g., CDMA, GSM, 3G, 4G, etc.), or a combination thereof. The method of communication between the clients 150 and the server 110 is not limited to any particular user interface or network protocol. In example embodiments, the user may interact with the education cloud server 110 via, for example, a web browser, locally installed software, or a mobile app.

The education cloud server 110 and its functional components are implemented using one or more computers comprising components such as a processor, memory, network interface, and storage, and other well known components. Each of the functional modules of the education cloud server 110 may be implemented as computer-executable program instructions stored to a non-transitory computer-readable storage medium. In operation, the computer-executable program instructions are loaded into a memory and executed by one or more processors. Alternative embodiments of the education cloud server 110 may lack components described herein and/or distribute the described functionality among the components in a different manner. Additionally, the functionalities attributed to more than one component can be incorporated into a single component.

A user interface module 112 provides interfaces available to students and instructors for interacting with the web-based education system 100. In one embodiment, the user interface module 112 provides an interface that enables users to register an account with the web-based education system 100. A profile for each registered user is stored to a user accounts database 142 and may include information about the user such as name, location, stated interests, (e.g., in keyword or natural language form), predicted interests, times/days available for courses, demographic information, enrolled courses, previously completed courses, prior course searches, prior course requests, course performance, etc. Different or additional information may be stored in association with instructors or teaching assistants such as, for example, stated or predicted areas of expertise, qualifications, times available to teach, prior courses taught, teacher feedback or ratings, etc. The information in the user profile may be used to automatically provide course recommendations tailored to different users as will be described below. Thus, in one embodiment, users are encouraged to enter as much information about themselves as possible to enable the web-based education system 100 to provide better course recommendations.

The user interface module 112 furthermore provides appropriate interface to enable users to participate in various aspects of the web-based education system 100. For example, the user interface module 112 provides interfaces to enable students to view available courses, search courses, enroll in new courses, review information about courses, access course documents or videos, view recommended courses, view most popular courses, view highest rated courses, etc. Instructors are provided interfaces for similar actions in addition to other instructor-specific actions such as posting course material, beginning a new course, sending student feedback, etc.

The user interface module 112 furthermore provides appropriate interfaces to enable instructors or other administrators to add new courses, which are subsequently stored to the course database 144. For example, in one embodiment, a text-based course summary is provided by the instructor for each course. The summary includes, for example, the description of the course content, list of keywords related to this course, the pre-requisite knowledge, the most suitable student demographics, etc. Course documents such as assignments, syllabus, reading materials, lecture slides, etc. may also be added to the course database 144 via the user interface.

The learning module 114 generates a topic model and stores the topic model to the topics model database 148. The topics model comprises a plurality of topics with each topic including a list of words associated with the topic and a probability of each word appearing in association with a particular topic. The topic model is used to automatically determine topics that may be of interest to particular users and to automatically determine topics associated with a particular course offering. These topics can then be matched to find courses of interest to a particular user as will be described in further detail below. Using a topic-based approach enables the web-based education system 100 to matches users to courses even when no exact keyword matches are found between the user's stated interest and the course description. In one embodiment, the topic model may be obtained from an external source, rather than being generated by the education cloud server 110.

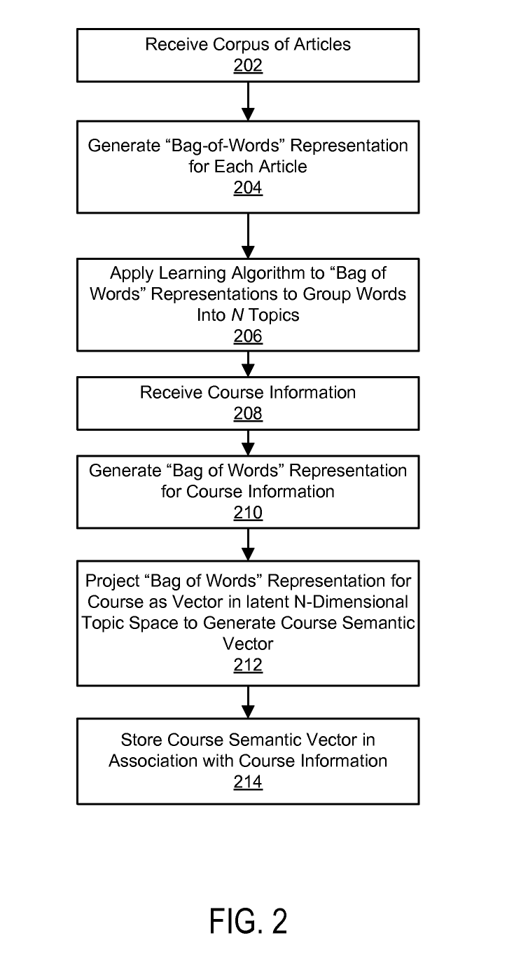

In one embodiment, the learning module 114 processes information pertaining to different courses available in the web-based education system 100 and stores the course information to the courses database 144. In one embodiment, the learning module 114 applies a learning algorithm based on the stored topic model to automatically determine topics associated with a particular course based on available course information. A process for determining topics associated with a particular course are described in further detail below with respect to FIG. 2.

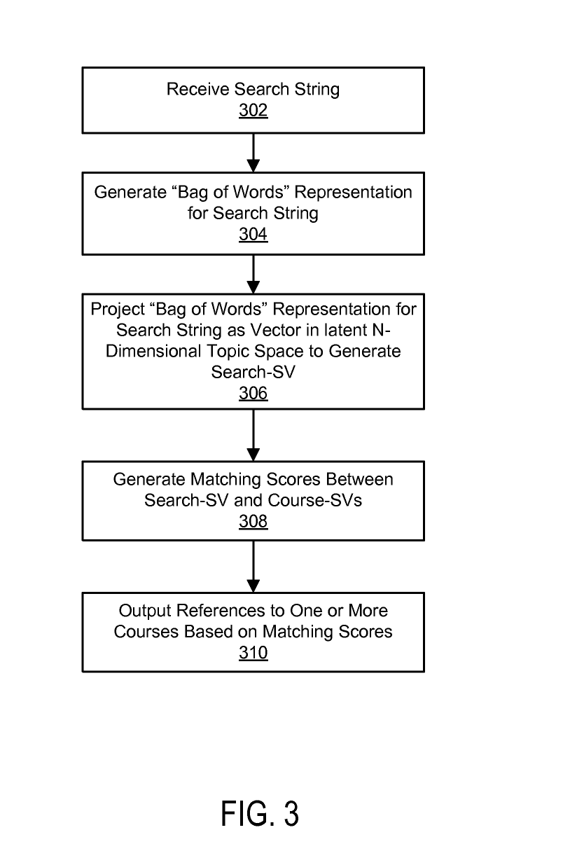

The search module 116 determines courses relevant to a particular search query. In one embodiment, the search module 116 uses the learning algorithm to determine topics associated with the search query and performs a topic-based search to determine courses relevant to the search query. An example embodiment of a process for performing a course search is described in further detail below with respect to FIG. 3.

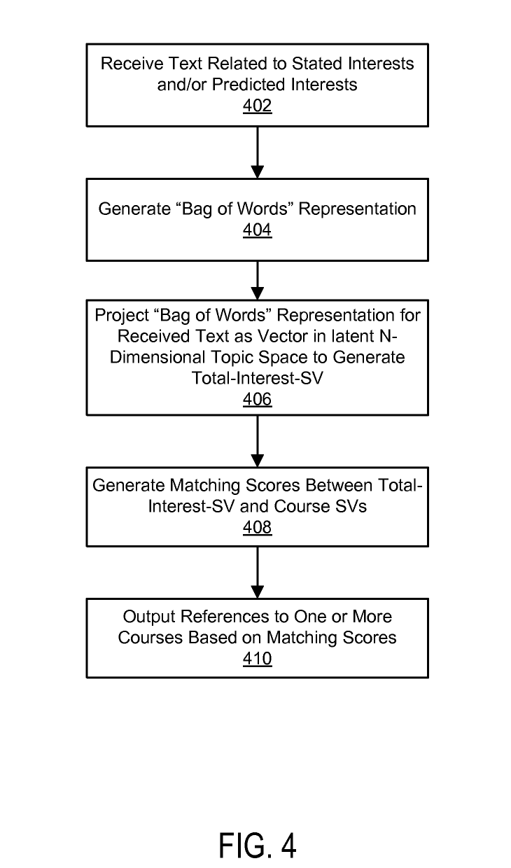

The recommendations module 118 automatically provides course recommendations to users based on information stored in the user profile and course information stored in the course database. For example, in one embodiment, the recommendation module 118 applies a learning algorithm based on the topics model from the topics model database 148 to match topics of interest to a particular user with topics associated with a particular course. The recommendations module 118 may furthermore provide recommendations to instructors for courses that an instructor may be particularly suitable to teach based on the information associated with the instructor's profile. The recommendations module 118 may furthermore apply a learning algorithm to learn relationships between topics and therefore provide predictability about which other topics may be of interest to a particular user based on known topics of interest. Example embodiments of processes for determining and ranking recommendations are described in further detail below with respect to FIGS. 4-6.

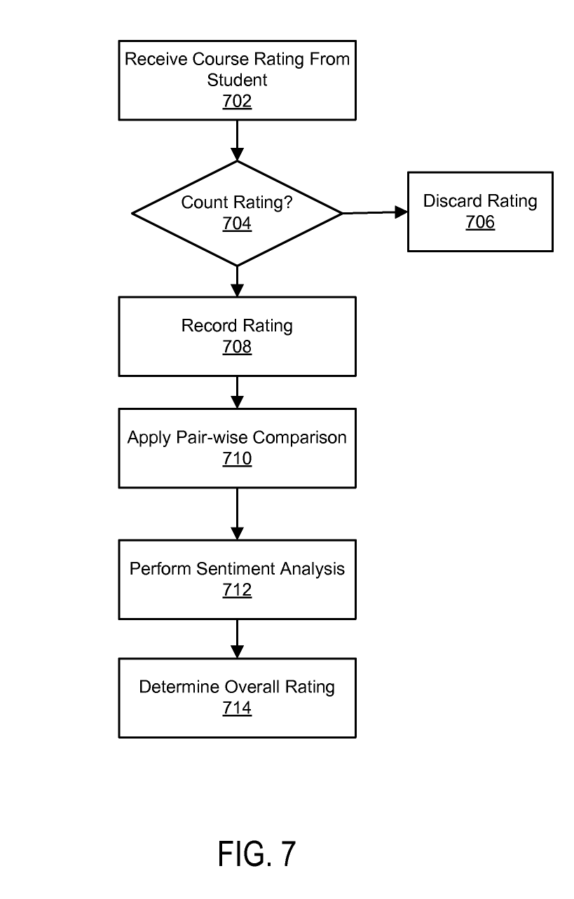

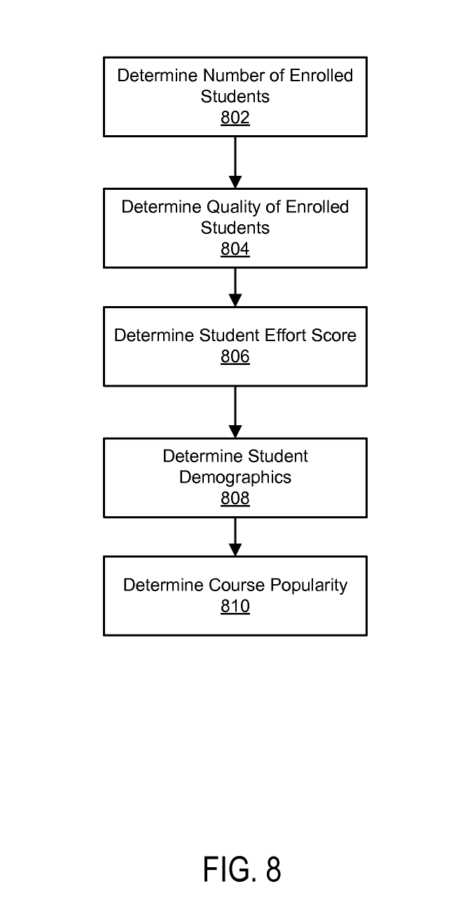

The course satisfaction module 120 generates information such as course ratings, course popularity scores, etc. indicative of users' overall satisfaction with a course. The course satisfaction information can be provided to prospective students or instructions searching for courses of interest. Example embodiments of processes for generating course satisfaction information are described in further detail below with respect to FIGS. 7-8.

### EXAMPLE OPERATION AND USE

FIG. 2 illustrates an embodiment of a machine learning method for learning topics associated with a database of online education courses. The learning module 114 receives 202 a corpus of articles covering a wide variety of different subjects of interest. The corpus may be collected from, for example, articles posted on internet portals and forums of various subjects. Each article is decomposed into a set of individual words to generate 204 a “bag-of-words” representation for each article. In the bag-of-words representation, the structural aspects of the article (e.g., sentence and paragraph structure) are lost, and the article is reduced to a set of words with no specified order. The bag-of-words representation indicates which words appear in each article and the number of occurrences of each word in the article. Additionally, in one embodiment, non-meaningful common words like “a”, “the”, “is”, etc. are omitted in the bag-of-words representation.

The learning module 114 then applies 206 a learning algorithm to the bag-of-words representation to group words into a plurality of topics (e.g., an integer N topic). For example, in one embodiment, words are grouped into topics based on the statistical co-occurrences of words within the individual articles. Each topic is represented by the list of words associated with the topic and a probability that the particular word will appear within an article associated with that topic. For example, in various embodiments, the learning module 114 may be configured to determine between 500 and 2,500 topics, although different embodiments may determine a different number of topics. In one embodiment, the learning module 114 applies a Latent Dirichlet Allocation (LDA) algorithm to determine the topics, although other known learning algorithms can be used. The topics become N axes of a latent N-dimensional semantic space, where N is the number of topics. A bag-of-words representation for an article can be represented as a weighted combination of topics and each article can therefore be represented as a vector (or point) in the N-dimensional semantic space.

Using the learned topics, the learning module 114 can automatically assign topics to courses. For example, in one embodiment, the learning module 114 receives 208 course information for each course in the course database 144. The course information may include a plurality of documents or other information pertaining to the course such as, for example, a course description, teaching slides, course documents, assignments, a syllabus, keywords provided by a course organizer, or other information that provides some contextual information about the course. A bag-of-words representation is then generated 210 from the course information to obtain a list of words associated with the course and a number of occurrences (or weight) of each word. In one embodiment, keywords provided by the course organizer (if present) are counted multiple times (e.g., 10 or 100 times) to increase their weight in the bag-of-words representation since the keywords are likely to be the most relevant words for the purpose of determining the topics. In other embodiments, the counts for words associated with other components of the course information can be increased or decreased to give them more or less weight in the bag-of-words representation.

The learning module 114 then projects 212 the bag-of-words representation of the course into the N-dimensional semantic space by representing the bag-of-words as a weighted combination of topics. This produces a vector referred to herein as a course semantic vector (course-SV). The course-SV represents a weighted distribution of the topics associated with the course. The course-SV is stored 214 in association with the course in the course database 144.

FIG. 3 illustrates an embodiment of a process for performing a search for an online course based on the course-SVs described above. The search module 116 receives 302 a search string (e.g., keywords or natural language input) from a user. A bag-of-words representation is then generated 304 for the search string. The search module 116 projects 306 the bag-of-words representation into the N-dimensional semantic space by representing the bag-of-words for the search string as a weighted combination of the N topics. The projection vector is referred to herein as a search semantic vector (search-SV) and represents a weighted distribution of the topics associated with the search string. Matching scores are then generated 308 between the search-SV and the course-SVs. For example, in one embodiment, the matching scores are computed based on the distances (e.g., a Euclidean distance in the N-dimensional space, or Jensen-Shannon divergence distance, or other distance definitions) between the search-SV and the stored course-SVs. The distance represents a relevance of a course to the search string. For example, courses associated with course-SVs with shorter distances to the search-SV are generally more relevant to the search query. The search module 116 then outputs 310 references to one or more courses based on the matching scores. For example, in one embodiment, the search module 116 provides a list of courses ranked based on matching score (e.g., highest to lowest).

FIG. 4 illustrates an embodiment of a process for generating recommendations for a course based on a user's stated and/or predicted interests. In one embodiment, the recommendations module 118 automatically generates course recommendations for a particular user without the user necessarily having to input a search request. For example, course recommendations may appear automatically, for example, on the user's home page or may be displayed responsive to a user's request for course recommendations.

The recommendations module 118 receives 402 text related to stated and/or predicted interests of a user. For example, stated interests may be directly received from the user and stored as part of the user's profile. The user profile may also store other sources of information related to user's behavior within the web-based education system that may pertain to predicted interests of the user. For example, the user profile database 142 may store information such as courses that the user has previously taken, search inputs entered by the user, requests for course descriptions, feedback and comments that the user has provided regarding various courses, articles or other documents that the student has read, course requests entered by the user, etc. Any text associated with this information may provide predictions about the user's interests.

A bag-of-words representation is then generated 404 from the collective set of words in any obtained text related to the user's stated and/or predicted interests. In one embodiment, one or more components of the input text obtained above we can be counted multiple times (e.g., 10× or 100×) to increase its weight in the bag-of-words representation. For example, in one embodiment, the user's search keywords and course requests are increased in weight because they are very strong predictors of the user's actual interests. In one embodiment, articles read by the user are reduced in weight in the bag-of-words representation (e.g., 0.1× or 0.01×), because articles are a weaker predictor of the user's actual interest since they are often viewed casually.

The bag-of-words representation is then projected 406 into the N-dimensional semantic space by representing the bag-of-words as a weighted combination of topics. The vector is referred to herein as a total interest semantic vector (total-interest-SV) and represents a weighted distribution of topics associated with the user's stated and/or predicted interests. Each component of the total-interest-SV represents the strength of the user's total interest along that semantic topic axis. Matching scores are then generated 408 between the total-interest-SV and the course-SVs. For example, in one embodiment, the matching scores are computed based on the distances between the total-interest SV and existing course-SVs. References to one or more courses are then outputted 310 based on the matching scores. For example, in one embodiment, the recommendations module 118 provides a list of courses ranked based on matching score (e.g., highest to lowest). In another embodiment, additional factors besides the matching score may also be considered when determining a search rank for courses such as course rating as course popularity as will be described in further detail below.

In another embodiment, the recommendations provided by the recommendations module 118 can be further improved by analyzing the collective behavior of many students to determine topics that are correlated to each other and therefore more likely to be of interest to a particular user. Using this approach, topics of interest can be inferred for a particular student though the topic would not be directly apparent from the student's total-interest-SV.

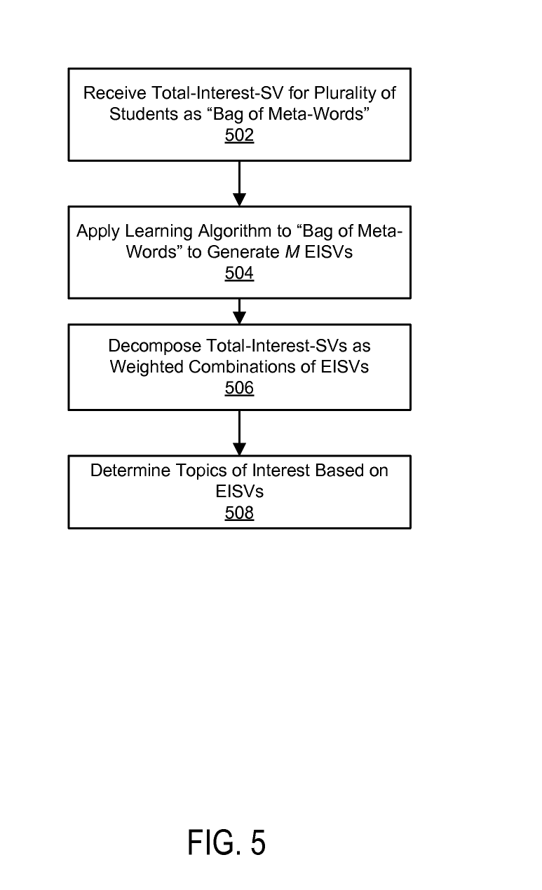

FIG. 5 illustrates an embodiment of a process for learning relationships between a plurality of topics based on the collective behavior of users. The recommendations module 118 first receives 502 the total-interest-SVs for a plurality of students. Here, each student is treated as a “meta-article” comprising a “bag of meta-words,” where each of the meta-words is one of the N semantic topics. The student's total-interest-SV then corresponds to the bag of meta-words where the individual vector component is the frequency of that meta-word in the bag-of-meta-words.

The recommendations module 118 then applies 504 a learning algorithm to the bag-of-meta-words for the plurality of different students to generate M meta-topics, where each meta-topic comprises an “Eigen-Interest” (EI). Each EI (or meta-topic) is a group of semantic topics that tend to appear together as being of interest to a single student. Each EI (or meta-topic) comprises a vector in the N-dimensional semantic space, where the component on a semantic topic axis represents the probability of a semantic topic appearing in the EI. This vector is referred to herein as an Eigen-Interest-Semantic-Vector (EISV).

Then, for each student, the learning algorithm can decompose 506 their total-interest-SV as a weighted combination of the M EISVs. The recommendations module 118 can then determine 508 topics of interest for a user based on the EISVs. For example, the EISV with the highest weight, or a plurality of the EISVs with the highest weights (e.g., top 5 EISV for a student), represent groups of topics that are most likely to be of interest to the student.

The students EISV can be analyzed in conjunction with the total-interest-SV to determine a wider range of topics that may be of interest to a particular user. For example, a matching score between the course-SV and one or more of the student's top weighted EISVs can be determined. If a course-SV has a good match to any of the top weighted EISVs, there is a high probability that the user is interested in the course and this information can be used to supplement the recommendations generated for that user.

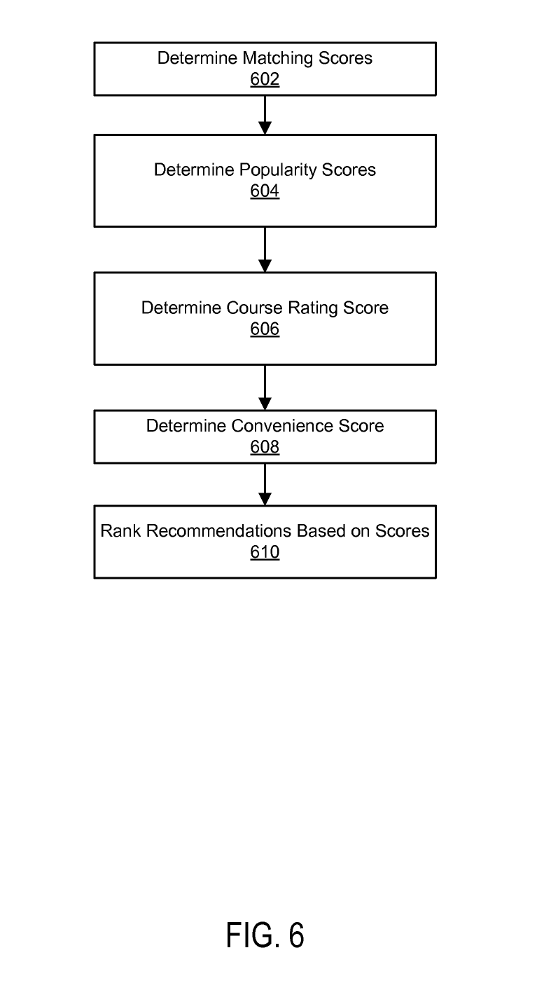

FIG. 6 illustrates an embodiment of a process for ranking course recommendations provided to a particular user. The recommendations module 118 determines 602 a matching score between a plurality of course-SVs and the student's total-interest-SV and/or one or more EISVs as described above. The recommendations module 118 further determines 604 a popularity rating for each of the courses as will be described in further detail below with respect to FIG. 8. The recommendations module 118 then determines 606 a course rating score for each course as will be described in further detail below with respect to FIG. 7. A convenience score 608 is also determined based on a matching metric between the course schedule and the user's scheduling availability. The course recommendations are then ranked 610 based on one or more of the scores described above.

FIG. 7 illustrates an embodiment of a process for generating course rating scores for courses. The course satisfaction module 120 receives 702 a course rating from a student. The rating may be received, for example, in response to a survey provided to the students during or upon completion of the course. For example, in one embodiment, each student is asked to rank the course between 1 and 10 (poor to excellent), although other rating scales may also be used. The course satisfaction module 120 then determines 704 if the score should be counted based on how representative the score is of the overall satisfaction associated with the course. For example, in one embodiment, a score is counted only if the student completed a significant portion of the course (e.g., more than 75%). In another embodiment, the course satisfaction module 120 determines not to count a score if it is received from a student that consistently gives only top scores or consistently gives very negative scores. In another embodiment, the course satisfaction module 120 may determine not to count scores that are significant outliers relative to scores received from other students. If the course satisfaction module 120 determines not to count the score in step 704, the rating is discarded 706. Otherwise the rating is recorded 708. In an alternative embodiments, the course satisfaction module 120 may instead assign a lower weight (rather than completely discarding) to ratings that are deemed unrepresentative of the overall satisfaction associated with a particular course.

The course satisfaction module 120 then applies 710 pair-wise comparisons to reduce the effect of bias between different students in scoring. For example, one student may tend to give higher scores than another student even if their actual satisfaction of the class is the same. To compensate for this, a student's baseline score may be used as a common factor when comparing different courses to generate a pairwise comparison rating.

The course satisfaction module 120 may also perform 712 a sentiment analysis algorithm to natural language comments provided by students about a particular course. Here, the number of sentiment-bearing words may be counted and weighted by their strength to determine an overall sentiment rating. An overall rating score for a particular course is then determined 714 based on the pairwise comparison rating and the sentiment rating.

FIG. 8 illustrates an embodiment of a process for generating a course popularity score for a particular course. The course satisfaction module 120 determines 802 a number of students enrolled in the course. In various embodiments, this may include current enrollment, historical enrollment or a combination of both. The course satisfaction module 120 determines 804 a quality measure for the enrolled students. The quality measure may be based on a variety of different factors including, for example, how many other classes the student has taken, the students' performance in other classes, etc. Generally, courses attracting higher quality students will increase the courses popularity score. A student effort score 806 is also determined to represent how much effort students are willing to put forth to participate in the course. For example, the local time for a student when an interactive session of the course occurs may indicate the amount of the students' effort in attending that class (e.g., higher effort if the student is forced to participate at an inconvenient local time). A student demographic measure 808 is also determined. Since different class style on the same subject may be suitable to different demographics of student population, the class' popularity may be ranked differently for different student demographics. A course popularity score is then determined 810 based on one or more of the factors above.

In another embodiment, the learning algorithm described above can be applied to course categorization. Hierarchical topic space may be built using the learning algorithm described above, and that hierarchical topic structure may itself be used as the hierarchical categories. Alternatively, well-established course catalogs used in universities, middle schools, vocational schools, etc. can be used. Here, bag-of-words representations are generated from descriptions for each category or sub-category in the course catalogs. The learning algorithm described above projects the course categorization bag-of-words to the N-dimensional semantic space to generate a category semantic vector (category-SV) for each category and sub-category. Courses can then be associated with categories or sub-categories based on the matching score between category-SVs and course-SVs.

In yet another embodiment, the learning algorithm described above can be used to direct new course requests to the appropriate instructors that are likely to be interested in and qualified to teach a particular course. Here, a teacher semantic vector (teacher-SV) can be generated for each instructor based on stated interests, areas of expertise, courses previously taught, monitored behaviors, or other information relevant to matching the instructor with a course. When a user enters a request for a new course, the text from the request can be represented as a bag-of-words, and projected to the N-dimensional semantic space. Then these requests can be clustered, e.g., using K-mean algorithm, in the semantic topic space. Each cluster center can then be identified as a cluster request semantic vector (cluster-request-SV). One or more suitable instructors and/or teaching assistants can then be identified based on the matching of the clustered-request-SV and teachers-SVs.

In yet another embodiment, the learning algorithm described above can be used to generate targeted advertisements. For example, advertisements may be provided pertaining to new courses that become available. For example, a semantic analysis of the course material may be performed and targeted advertisements sent to students that are likely to be interested. Additionally, third-party advertisements may be presented that are targeted to students based on their interests. For example, bag-of-words representations for a plurality of advertisements from an advertising database can be generated and projected to the N-dimensional semantic space to generate advertisement semantic vectors (ad-SVs). The ad-SVs can then be matched to the student's total-interest-SVs (or EISVs) to determine advertisements of interest to different users. In one embodiment, the targeted advertisements can include job recruitment advertisements to target students that are likely to have matching qualifications and interests for the job.

### ADDITIONAL FEATURES OF THE WEB-BASED EDUCATION SYSTEM

In one embodiment, the web-based education system 100 provides an intuitive easy-to-navigate interface for finding courses that includes, for example, categories of classes, course summaries, instructor biographies, etc. In one embodiment, the web-based education system 100 provides an open platform that allows third parties to develop applications for use with the web-based education system 100. These applications can be made available for purchase by the students or teachers.

In one embodiment, the web-based education system 100 provides an easy to use interface for instructors to generate course content. For example, in one embodiment, an application includes various tools to enable an instructor to record a class. For example, an instructor application may enable features such as recording video, inputting course material (e.g., slide shows or documents), capturing content written by the instructor on a virtual chalkboard, facilitating question and answer sessions, etc. Students are able to view the various components of the course via a user interface. The lessons can be distributed in real-time via live streaming or stored for later viewing.

In one embodiment, the web-based education system 100 furthermore includes a networking infrastructure that enables students to easily form study and discussion groups and share feedback and or comment. For example, the web-based education system 100 may provide chat rooms or group forums available to students and instructors, and may leverage existing social networking sites. The web-based education system 100 may furthermore automatically recommend connections between students for forming study groups.

In one embodiment, the web-based education system 100 further comprises a tuition management and payment system that enables students to pay for courses. In one embodiment, the web-based education system 100 apportions a small fee from the tuition paid by students to the teachers to an administrator of the education cloud server 110. In one embodiment, premium account fees may be collected for enhanced functions otherwise unavailable such as, for example, large amounts of storage.

Additionally, the web-based education system 100 may be configured to present advertisements and recommendations for education supplies targeted to students in particular classes, thus providing additional sources of revenue for the administrator of the education cloud server 110. Furthermore, advertisements may be targeted to students based on the relevant interests of the student (e.g., based on the student's total-interest-SV or EISVs) as discussed above.

Upon reading this disclosure, those of skill in the art will appreciate still additional alternative designs for a web-based education system 100. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

1. A computer-implemented method for matching prospective students with courses in a web-based education system, the method comprising:
receiving a plurality of course vectors, each course vector associated with a course, and each course vector representing the course as a weighted distribution of topics associated with the course derived from a machine learning algorithm;
receiving a total interest vector for a user, the total interest vector representing interests of the user as a weighted distribution of topics associated with the user derived from the machine learning algorithm;
generating, by a processor, matching scores between the total interest vector and the plurality of course vectors; and
outputting references to one or more courses based on the matching scores.

2. The computer-implemented method of claim 1, further comprising:
receiving a learned topic model, the learned topic model indicating weighted distributions of words associated with a plurality of different topics, the topic model derived from the machine learning algorithm;
receiving text related to interests of the user, the text derived from a user profile associated with the user;
generating a bag of words representation for the received text, the bag of words representation comprising a set of words appearing in the received text and a number of occurrences of each of the words in the received text;
applying the learned topic model to project the bag of words representation to a topic space to generate the total interest vector, the total interest vector representing the bag of words representation as a weighted distribution of topics according to the learned topic model.

3. The computer-implemented method of claim 2, wherein the text derived from the user profile comprises at least first text associated with a first source of information and second text associated with a second source of information; and
wherein generating the bag of words representation comprises counting each word obtained from the first text multiple times.

4. The computer-implemented method of claim 1, further comprising:
receiving a plurality of total interest vectors associated with different users;
learning a plurality of eigen-interest vectors based on the plurality of total interest vectors associated with the different users using the machine learning algorithm, the eigen-interest vectors each representing a weighted distribution of topics;
representing the total interest vector for the user as a weighted combination of eigen-interest vectors; and
determining topics of interest for the user based on at least a highest weighted one of the eigen-interest vectors.

5. The computer-implemented method of claim 1, further comprising:
determining popularity scores for a plurality of courses associated with the plurality of course vectors;
determining course rating scores for the plurality of courses;
determining convenience scores for the plurality of courses, the convenience score for a given course based on a convenience metric associated with a plurality of users enrolled in the given course; and
ranking the plurality of courses based on the matching scores, the popularity scores, the course rating scores, and the convenience scores.

6. The computer-implemented method of claim 1, further comprising:
receiving a learned topic model, the learned topic model indicating weighted distributions of words associated with a plurality of different topics;
receiving a input search string;
generating a bag of words representation for the input search string, the bag of words representation comprising a set of words appearing in input search string and a number of occurrences for each of the words in the input search string;
applying the learned topic model to project the bag of words representation to a topic space to generate a search vector, the search vector representing the bag of words representation as a weighted distribution of topics according to the learned topic model; and
determining one or more courses relevant to the search string based on a matching scores between the plurality of course vectors and the search vector.

7. The computer-implemented method of claim 1, further comprising:
receiving a learned topic model, the learned topic model indicating weighted distributions of words associated with a plurality of different topics;
receiving a plurality of requests for new courses;
generating a bag of words representation for the received plurality of requests for new courses, the bag of words representation comprising a set of words appearing in text associated with the plurality of requests and a number of occurrences for each of the words in the text;
applying the learned topic model to project the bag of words representation to a topic space to generate a course request vector, the course request vector representing the bag of words representation as a weighted distribution of topics according to the learned topic model;
clustering the course request vectors to generate one or more clustered course request vectors; and
determining one or more instructors suitable to teach one of the new courses based on the clustered course request vectors.

8. A non-transitory computer-readable storage medium storing computer-executable instructions for matching prospective students with courses in a web-based education system, the instructions when executed by a processor causing the processor to perform steps including:
receiving a plurality of course vectors, each course vector associated with a course, and each course vector representing the course as a weighted distribution of topics associated with the course derived from a machine learning algorithm;
receiving a total interest vector for a user, the total interest vector representing interests of the user as a weighted distribution of topics associated with the user derived from the machine learning algorithm;
generating matching scores between the total interest vector and the plurality of course vectors; and
outputting references to one or more courses based on the matching scores.

9. The non-transitory computer-readable storage medium of claim 8, the instructions when executed further causing the processor to perform steps including:
receiving a learned topic model, the learned topic model indicating weighted distributions of words associated with a plurality of different topics, the topic model derived from the machine learning algorithm;
receiving text related to interests of the user, the text derived from a user profile associated with the user;
generating a bag of words representation for the received text, the bag of words representation comprising a set of words appearing in the received text and a number of occurrences of each of the words in the received text;
applying the learned topic model to project the bag of words representation to a topic space to generate the total interest vector, the total interest vector representing the bag of words representation as a weighted distribution of topics according to the learned topic model.

10. The non-transitory computer-readable storage medium of claim 9, wherein the text derived from the user profile comprises at least first text associated with a first source of information and second text associated with a second source of information; and
wherein generating the bag of words representation comprises counting each word obtained from the first text multiple times.

11. The non-transitory computer-readable storage medium of claim 8, the instructions when executed further causing the processor to perform steps including:
receiving a plurality of total interest vectors associated with different users;
learning a plurality of eigen-interest vectors based on the plurality of total interest vectors associated with the different users using the machine learning algorithm, the eigen-interest vectors each representing a weighted distribution of topics;
representing the total interest vector for the user as a weighted combination of eigen-interest vectors; and
determining topics of interest for the user based on at least a highest weighted one of the eigen-interest vectors.

12. The non-transitory computer-readable storage medium of claim 8, the instructions when executed further causing the processor to perform steps including:
determining popularity scores for a plurality of courses associated with the plurality of course vectors;
determining course rating scores for the plurality of courses;
determining convenience scores for the plurality of courses, the convenience score for a given course based on a convenience metric associated with a plurality of users enrolled in the given course; and
ranking the plurality of courses based on the matching scores, the popularity scores, the course rating scores, and the convenience scores.

13. The non-transitory computer-readable storage medium of claim 8, the instructions when executed further causing the processor to perform steps including:
receiving a learned topic model, the learned topic model indicating weighted distributions of words associated with a plurality of different topics;
receiving a input search string;
generating a bag of words representation for the input search string, the bag of words representation comprising a set of words appearing in input search string and a number of occurrences for each of the words in the input search string;
applying the learned topic model to project the bag of words representation to a topic space to generate a search vector, the search vector representing the bag of words representation as a weighted distribution of topics according to the learned topic model; and
determining one or more courses relevant to the search string based on a matching scores between the plurality of course vectors and the search vector.

14. The non-transitory computer-readable storage medium of claim 8, the instructions when executed further causing the processor to perform steps including:
receiving a learned topic model, the learned topic model indicating weighted distributions of words associated with a plurality of different topics;
receiving a plurality of requests for new courses;
generating a bag of words representation for the received plurality of requests for new courses, the bag of words representation comprising a set of words appearing in text associated with the plurality of requests and a number of occurrences for each of the words in the text;
applying the learned topic model to project the bag of words representation to a topic space to generate a course request vector, the course request vector representing the bag of words representation as a weighted distribution of topics according to the learned topic model;
clustering the course request vectors to generate one or more clustered course request vectors; and
determining one or more instructors suitable to teach one of the new courses based on the clustered course request vectors.

15. A system for matching prospective students with courses in a web-based education system, the system comprising:
a processor; and
a non-transitory computer-readable storage medium storing computer-executable instructions for, the instructions when executed by the processor causing the processor to perform steps including:
receiving a plurality of course vectors, each course vector associated with a course, and each course vector representing the course as a weighted distribution of topics associated with the course derived from a machine learning algorithm;
receiving a total interest vector for a user, the total interest vector representing interests of the user as a weighted distribution of topics associated with the user derived from the machine learning algorithm;
generating matching scores between the total interest vector and the plurality of course vectors; and
outputting references to one or more courses based on the matching scores.

16. The system of claim 15, the instructions when executed further causing the processor to perform steps including:
receiving a learned topic model, the learned topic model indicating weighted distributions of words associated with a plurality of different topics, the topic model derived from the machine learning algorithm;
receiving text related to interests of the user, the text derived from a user profile associated with the user;
generating a bag of words representation for the received text, the bag of words representation comprising a set of words appearing in the received text and a number of occurrences of each of the words in the received text;
applying the learned topic model to project the bag of words representation to a topic space to generate the total interest vector, the total interest vector representing the bag of words representation as a weighted distribution of topics according to the learned topic model.

17. system of claim 16, wherein the text derived from the user profile comprises at least first text associated with a first source of information and second text associated with a second source of information; and
wherein generating the bag of words representation comprises counting each word obtained from the first text multiple times.

18. The system of claim 15, the instructions when executed further causing the processor to perform steps including:
receiving a plurality of total interest vectors associated with different users;
learning a plurality of eigen-interest vectors based on the plurality of total interest vectors associated with the different users using the machine learning algorithm, the eigen-interest vectors each representing a weighted distribution of topics;
representing the total interest vector for the user as a weighted combination eigen-interest vectors; and
determining topics of interest for the user based on at least a highest weighted one of the eigen-interest vectors.

19. The system of claim 15, the instructions when executed further causing the processor to perform steps including:
determining popularity scores for a plurality of courses associated with the plurality of course vectors;
determining course rating scores for the plurality of courses;
determining convenience scores for the plurality of courses, the convenience score for a given course based on a convenience metric associated with a plurality of users enrolled in the given course; and
ranking the plurality of courses based on the matching scores, the popularity scores, the course rating scores, and the convenience scores.

20. The system of claim 15, the instructions when executed further causing the processor to perform steps including:
receiving a learned topic model, the learned topic model indicating weighted distributions of words associated with a plurality of different topics;
receiving a input search string;
generating a bag of words representation for the input search string, the bag of words representation comprising a set of words appearing in input search string and a number of occurrences for each of the words in the input search string;
applying the learned topic model to project the bag of words representation to a topic space to generate a search vector, the search vector representing the bag of words representation as a weighted distribution of topics according to the learned topic model; and
determining one or more courses relevant to the search string based on a matching scores between the plurality of course vectors and the search vector.
